(19) United States
(12) Patent Application Publication
(10) Pub. No.: US 2008/0027859 A1
(43) Pub. Date: Jan. 31, 2008

(54) PREFERRED CREDIT INFORMATION DATA COLLECTION METHOD

(75) Inventors: Michael G. Nathans, Annapolis, MD (US); Marcia A. Goldstein-Nathans, Annapolis, MD (US)

Correspondence Address: DLA PIPER US LLP;ATTN: PATENT GROUP, 500 8th Street, NW, WASHINGTON, DC, 20004-2131, US

(73) Assignee: PAY RENT, BUILD CREDIT, INC., Annapolis, MD (US)

(21) Appl. No.: 11/830,536

(22) Filed: Jul. 30, 2007

Related U.S. Application Data
(63) Continuation-in-part of application No. 11/467,408, filed on Aug. 25, 2006.
Application No. 11/467,408 is a division of application No. 10/309,018, filed on Dec. 4, 2002, now Pat. No. 7,139,734.
Application No. 11/467,408 is a continuation-in-part of application No. 10/392,849, filed on Mar. 21, 2003.

(51) Int. Cl. G06F 17/40; G06Q 90/00

(52) U.S. Cl. 705/38

(57) ABSTRACT

A consumer pays their bills using a bill payment service that reports actual payment information to a consumer reporting agency repository. The consumer requests the bill payment service to send their payment information to the CRA repository each month on their behalf to show they pay their bills on time when applying for credit. The bill payment service reports actual bill payment to the CRA reports on behalf of its customers requesting the reporting service. All bill payment data maintained in the CRA repository is maintained securely and will not be released without the consent of the consumer. The bill payment data maintained in the repository is used to report a credit score in addition to the payment data being reported, which occurs only when the consumer authorizes the release of the data.

### CROSS REFERENCE TO RELATED APPLICATIONS

This application is a continuation in part of U.S. application Ser. No. 11/467,408, filed Aug. 25, 2006, which is a division of U.S. application Ser. No. 10/309,018, filed Dec. 4, 2002, and is a continuation in part of U.S. application Ser. No. 10/392,849, filed Mar. 21, 2003. The entirety of all of these applications are incorporated herein by reference.

### BACKGROUND OF THE INVENTION

The present invention relates generally to the field of credit reporting and more particularly to the field of credit payment data collection and verification methods.

Traditional consumer credit payment data collection methods rely on obtaining payment information from the creditor. Using the traditional approach, creditors report payments either as “on time” or “late” in 30 day increments.

A problem with the traditional methodology is that many smaller creditors and “non-traditional” creditors such as apartment rental landlords, utility and telephone service providers do not report to traditional credit bureaus because of technical barriers and/or lack of convenience. This condition causes many consumers and small business owners that faithfully pay on time to not receive that recognition by automated credit underwriting technologies that rely on traditional credit data from the three major credit bureaus, Equifax, Experian, and TransUnion, as well as Dun & Bradstreet.

Distinct social and racial disparities associated with otherwise effective automated underwriting credit risk management technology have been observed since the introduction of this technology, especially in connection with traditional credit data collection and reporting practices wherein a creditor reports to one or more of the major credit bureaus. For example, the current housing credit application process for both residential leases and mortgages often presents a daunting problem to low and moderate income consumers, first-time homebuyers, and consumers with rehabilitated credit. In order to qualify for housing credit, such consumers must establish credit-worthiness using traditional credit instruments and payment history collection and reporting practices. However, the traditional methods used to establish credit-worthiness present distinct unfair disadvantages, especially to fiscally responsible low- and moderate-income consumers who pay their residential rent or private non-reported mortgage, utilities, phone, and other commonly recurring monthly bills on time, but who do not have other lines of credit PICO (Fair, Isaac & Co.) credit scores are automatically calculated by “traditional” credit bureaus for their subscribers using FICO's proprietary algorithms. These credit scores are in turn used by automated underwriting, scoring, and pricing models to establish credit-worthiness and ultimately determine the likelihood of default, whether the applicant will qualify for the housing, credit, insurance, utility or phone service sought and the price or security deposit they will pay.

One of the problems associated with traditional credit reporting methods is that no effort has been made in the market to systematically (i) collect residential rental lease, private mortgage, small auto lender, utility, or telephone payment data, (ii) assure data quality, (iii) prevent the effective prejudice of consumer's rights in the data collection process, and (iv) reduce the cost of processing payments while assuring privacy of the creditor/debtor relationship. The FICO scores generated for low- and moderate-income consumers who do not have traditional lines of credit, do not own their own homes, and/or whose mortgages are serviced by a non-reporting mortgage servicer are therefore based solely on traditional credit history (which is defined as credit for retail goods and services such as car loans or credit cards) and often do not include “housing” credit history (which is defined as residential lease or mortgage payments and other housing-related payments such as mobile home pad rent, and condominium and cooperative payments).

Traditional consumer credit data collection, management, and reporting practices are a problem in connection with housing credit for three (3) reasons. First, the FICO scores for low and moderate income consumers who make their residential lease, utility, and telephone payments on time are lower than they should be. Second, FICO scores that are based solely on retail (non-housing) credit information are not as accurate in predicting the likelihood of default on a residential mortgage or lease as a credit score in which housing credit data (if electronically accessible) is assessed and more heavily weighted than the retail credit data. This is because the correlation between an applicant's past housing credit payment behavior and their future housing credit payment behavior is believed to be a stronger default indicator than the correlation between past traditional (retail credit only) payment behavior and future housing credit payment behavior.

Yet another problem with the current system is that there is no check of the accuracy of the payment information that is reported to traditional credit bureaus. This is problematic for two reasons. First, it subjects consumers to potentially unscrupulous and unilateral payment reporting actions of creditors. Second, and of greatest concern, a consumer who rightfully withholds a payment due to a legitimate dispute (such as a landlord's failure to provide heat the winter, running water, or sanitary plumbing) can receive a “black mark” using traditional credit reporting methods, and have their credit damaged for many years because of the rightful withholding of payment. This potential threat effectively prejudices a consumer's legal rights in a residential lease transaction using traditional credit reporting methods.

The Preferred Credit Information (PCI) Data Collection Methodology is an equitable and cost-effective system and method that uniquely addresses the aforementioned problems, and mitigates the social and racial disparities associated with automated underwriting technology.

### SUMMARY OF THE INVENTION

The present invention provides a system and method for processing payments, resolving disputes, and collecting credit payment history information. The invention lowers barriers to credit that are presented by prior art techniques for consumers who pay their residential rent, mortgage, utilities, phone, and other monthly bills on time by collecting, managing, and making this payment history data electronically available to authorized subscribers. Subscriber creditors may rely on data collected, managed and made available by the invention as inputs to drive their automated credit scoring and underwriting models.

In one aspect of the invention, a creditor or a consumer creates a lock box at a financial institution such as a bank. In some embodiments, the lock box includes an escrow provision under which a consumer can designate payments to be held in escrow under certain pre-defined conditions (e.g., some breach of contract by an apartment landlord, such as failure to provide hot water, or the institution of a suit between the landlord and tenant). A consumer makes payments to the financial institution and (in embodiments with the optional escrow provision) designates the payment either for the creditor's lock box or for the escrow account. The financial institution applies non-escrowed funds to the creditor's account and reports all payments (whether escrowed or not), including a date of payment and an amount paid, to the creditor and to a centralized data repository. In this manner, the consumer is able to build a positive credit history as timely payments will be reflected in the repository's records. The consumer is also provided with a mechanism for maintaining a positive credit history in the event of a dispute with a creditor by continuing to make timely payments and designating them for the escrow account.

Payment data stored in the repository may be reported in a number of ways. In some embodiments, the repository reports both payment data (including the amount paid and the date of payment) and the credit terms applicable to the payment (including the amount due and date on which the amount was due). In other embodiments, a score based on both the payment data and the credit terms pertaining to the credit data is reported in addition to, or in lieu of, the payment data and applicable credit terms.

In yet other embodiments, only the payment data is reported. In still other embodiments, an indication of the frequency and/or regularity of the timing and amount of the payments is reported without regard to the applicable credit terms in lieu of, or in addition to, the payment date. Such embodiments operate on an assumption that a consumer who regularly makes payments (e.g., on or about the same day of each month in a same or similar amount) is making timely payments and is therefore a good risk. One example of such data is a variance for both the date and amount of a periodic payment.

In another aspect of the invention, all credit data maintained in the data repository is maintained securely and will not be released without the consent of the consumer. This benefits consumers in that it prevents their credit information from being sold without their express consent. This reduces the flow of unwanted junk mail and telephone calls from other lenders. This also protects the creditor as it reduces the flow of information to competitors.

In another aspect of the invention, the credit data maintained in the repository is used to report a residential housing score in which residential housing credit payment history is more heavily weighted than retail credit payment history. In some embodiments, the residential housing credit payments include mortgage, lease, utility, and phone bill payment information. The inducement for small private lenders and mortgage servicers to report mortgage payment information is provided by protecting the confidently of the creditor/debtor relationship, and by allowing mortgage services who do report payment information to access the information in a single centralized housing credit repository with the consent of the consumer. For housing credit risk management, this credit information adds considerable value to credit scores from traditional credit bureaus because it includes residential housing credit information, which is more predictive of future housing credit payment behavior than the information traditionally available from credit bureaus.

Another aspect of the invention provides a security system to protect against unauthorized release of a consumer's credit data from the repository. In preferred embodiments of the invention, each consumer is provided with a User Name (personal identification number) and a password. Furthermore, member creditors are assigned Subscriber numbers, which are to be maintained in confidence. Member Subscribers are creditors who have registered with the data repository and who have legitimate credit risk management needs for the information, e.g., employers, landlords, mortgage lenders, insurance, phone, and utility companies, etc. In order for any consumer credit information from the repository to be transferred to any creditor, service provider or employer, the consumer must authorize the release of the information to that creditor.

### BRIEF DESCRIPTION OF THE DRAWINGS

A more complete appreciation of the invention and many of the attendant advantages and features thereof will be readily obtained as the same becomes better understood by reference to the following detailed description when considered in connection with the accompanying drawings, wherein:

FIG. 1 is a system diagram illustrating the interconnection of a residential housing credit management computer with other computers according to one embodiment of the present invention.

FIG. 2 is a flowchart illustrating a credit data request process according to an embodiment of the present invention.

FIG. 3 is a flow chart illustrating residential housing credit payment processing according to an embodiment of the present invention.

### DETAILED DESCRIPTION

The present invention will be discussed with reference to preferred embodiments of methods and systems for collecting and distributing credit payment data. Specific details, such as types of data collected and dispute resolution mechanisms, are set forth in order to provide a thorough understanding of the present invention. The preferred embodiments discussed herein should not be understood to limit the invention. Furthermore, for ease of understanding, certain method steps are delineated as separate steps; however, these steps should not be construed as necessarily distinct nor order dependent in their performance.

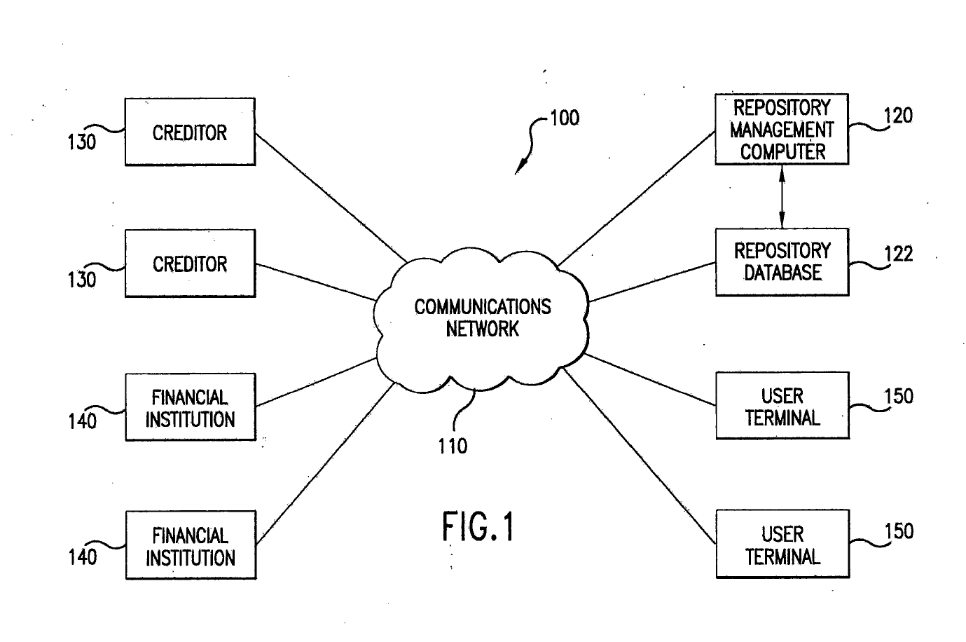

An exemplary system 100 according to the present invention is illustrated in FIG. 1. The system 100 includes a repository management computer 120 connected to a repository database 122. The repository database 122 holds some or all of the following data in various embodiments:

A Consumer Personal Information:

Consumer Name:
   First
   Last
   Middle Initial
   Maiden
Consumer Date of Birth (mm/dd/yy)
Consumer bioprint (signature, retina finger, etc.)
Consumer Address:
   Number
   Street Name
   Unit Number
   Building Name
   City
   Country
   State
   Zip Code
Consumer Address “As of” Date (mm/dd/yy)
Consumer Repository Account Number
Consumer User Name
Consumer Password (e.g., mother's maiden name)
Number of months as repository member
Number of consecutive on-time full payments
Number of escrow deposits
Number of Court Filings (w/ruling)
Delinquency frequency last 12/24 months:
   30 days; 60 days; 90 days; 120 days
Average payment date 0-90 for 12 months/24 months/overall
   B Consumer Loan Information:
Creditor Type (mortgage loan, home equity loan, apartment lease, mobile home pad, condominium, cooperative, utility or phone company, etc.)
Required Payment Amount
Required Payment Frequency
Credit Term
Required Payment Due DateCreditor Name
Loan ID number
Creditor Account Number (to which to credit payments)
Original Term
Remaining Term
Renewal Dates
Extension Dates
Modification Terms and Dates
Security Deposit Amounts
   C Payment Information:
Date on which payment was received
Time at which payment was received
Amount of payment received
Creditor Name
Loan ID Number:
Difference (in dollars) between required and actual payment
Difference (percent) between required and actual payment
Difference in days between date payment was made and due date
   D Creditor Information
Creditor Name
Creditor EIN
Creditor Address:
   Number
   Street Name
   Unit Number
   Building Name
   City
   Country
   State
   Zip Code
Creditor Servicing Contact Name (if different):
   Contact Phone Number
   Contact email address
Creditor assigned Consumer Account Number(s)
Creditor Repository Data Reporting ID Number
Creditor Repository Data Subscriber ID Number
Creditor Repository Data Reporting Trustee Name (i.e., bank lock box service provider)
Creditor Repository Data Reporting Trustee ID Number
Creditor Repository Data Reporting:
   Contact Name
   Contact Phone Number
   Mailing Address
   E-mail Address
   Contact Password

The repository management computer 120 acts as a gatekeeper to ensure that any information entering the repository database 122 is valid and, more importantly, that only properly authorized consumer credit information enters and leaves the repository database 122.

The repository management computer 120 is connected to a secure communications network 110. The communications network 110 may be any form of secure communications network, and preferably comprises the Internet. Those of skill in the art will recognize that many possible forms of secure communications networks are possible. These different forms will not be discussed in further detail herein to avoid obscuring the present invention. Also connected to the communications network 110 are a plurality of creditor computers 130, financial institution computers 140, and user terminals 150. Creditor computers 130 provide a means by which creditors can make requests for credit payment information from the repository management computer 120. Financial institution computers 140 report payments to the repository management computer 120. User terminals 150 allow users to authorize release of their credit data to residential housing credit providers and allow consumers to obtain copies of their records from the repository. It should be understood that a single computer or computer system can perform one or more of the functions of the devices shown in FIG. 1. For example, the repository management computer 120 and the repository database 122 may both be present in a single computer or computer system. Similarly, the functions of the creditor computers 130 and user terminals 150 may be combined in a single computer or system as described below.

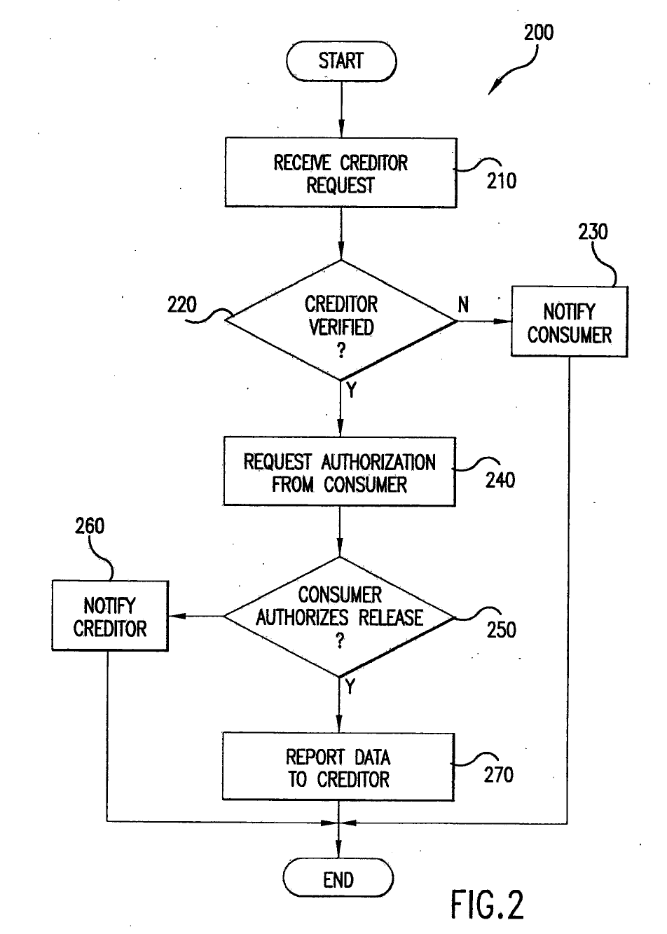

The processing that occurs at the repository management computer 120 when a consumer applies for credit is illustrated in the flowchart 200 of FIG. 2. The repository management computer 120 receives a request for credit data at step 210. The repository management computer 120 verifies the request at step 220. In some embodiments, the verification procedure includes some or all of the following checks: the Creditor Repository Data Subscriber ID Number must match the number retained in the database 122; the Creditor Repository Data Reporting Contact or User's Name associated with the request must match the Creditor Repository Data Reporting Contact or User's Name in the database 122, and a password provided with the request must match the Creditor Repository Data Reporting Contact or User's Password in the database 122. If the verification process fails, a notice of the unauthorized attempt is sent to the consumer whose credit was requested at step 230 and the process ends. The notification may be viewed in real time using the Internet, or by telephone, email, regular mail, or any other means.

If the verification process is successful, authorization is requested from the consumer at step 240. The request may be processed in real time using the internet, come by telephone, mail, email, or any other means. Additionally, in some embodiments, it is possible for a consumer to pre-authorize the release of credit data. One important aspect of the invention is the security of the data. As discussed above, in preferred embodiments of the invention, consumers are provided with a User Name and password that must be used in order to successfully authorize the release of the consumer's credit data. Other identification techniques (e.g., digital signature recognition retinal or finger scan) may be employed in alternative embodiments.

It should be noted that it is also possible for a credit or service provider, or employer to obtain the consumer's authorization and submit the authorization along with the data request. When a consumer applies for housing, credit, insurance, utility hook-up, phone service or employment, the consumer provides authorization to check the major credit bureaus along with the PCI data repository.

If the release of the data has been not authorized at step 250, a notice is sent to the creditor at step 260. If the release of the data has been authorized at step 260, the data is reported to the PCI subscriber at step 270. The report is preferably sent electronically, but may be sent by other means including fax and mail. The PCI subscriber then uses this information in determining whether or not to accept the consumer's application, and/or how to price the credit. It should be understood that references to reporting the data to a PCI subscriber includes reporting the data to an application processor designated by the PCI subscriber rather than to the PCI subscriber itself.

The report sent at step 270 may take various forms. In some embodiments, the credit repository 122 stores both consumer loan information (including the required payment amount and payment frequency) and the payment information (including date and amount of payments received and differences in dollars or as a percentage between the amount due and the payment received as well as differences between the due date for the payment and the payment date, it being understood that the foregoing differences can be calculated using the consumer payment obligation information). In such embodiments, the foregoing payment data may be included in the report. In other embodiments, a score calculated on the basis of some or all of the foregoing data may be reported. In other embodiments, the consumer payment obligation information is not included in the credit repository 122. In such embodiments, the report may include the dates and amounts of payments. This data may be used to infer a timeliness of the payment data. For example, if a consumer makes a payment of an identical amount almost every month to a same party or payment processors then it can be inferred that the payment is due each month. In other embodiments, one or more values or scores can be calculated indicating a frequency and/or regularity of the time and amount of the payments. For example, a mean and variance for both the timing and the amount of a series of regular (e.g., monthly) payments can be calculated. In instances where payment data for multiple payments in a given period exists (e.g., a consumer generally makes two payments each month, one at approximately $1,500 and a second at approximately $300, such as might be the case for mortgage and car payments), the payments may be separated and separate means and variances for each of the series of payments may be calculated. These calculated values may be reported in place of, or in addition to, the “raw” payment data.

If the consumer's application is accepted, the PCI subscriber creates an account for the consumer to use with the creditor's lock box at the creditor's bank or other financial institution of the creditor's choice. The consumer then begins sending regular payments to the creditor's lock box. These payments can include monthly mortgage payments in the case of a mortgage, lease payments and security deposits in the case of a lease, utility, and phone bill payments.

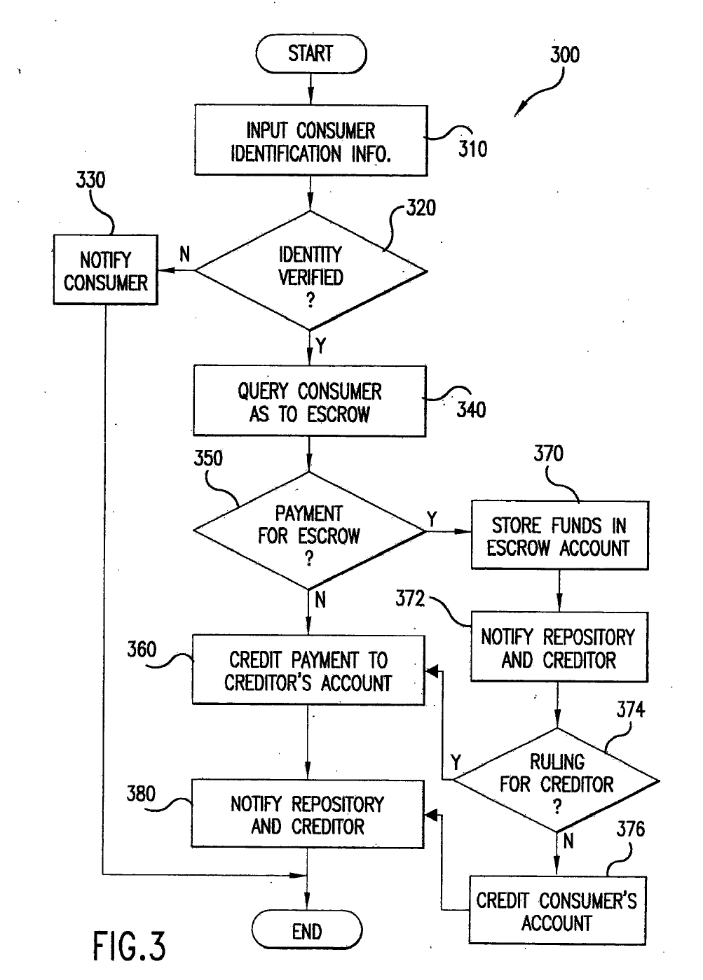

The processing performed by the bank/financial institution computer 140 is illustrated in the flowchart 300 of FIG. 3. When making a payment the consumers identification information is input at step 310. The identification information may be input by swiping a striped card in a card reader, by entering an account number, or other means. The emphasis in this step is properly identifying the consumer so that the payment made by the consumer is sent to the correct creditor and so that the consumer gets the proper credit for making the payment. Accordingly, in some embodiments, entry of a password or User Name is not required at this step. If the identification of the consumer is not verified at step 320, the consumer is notified at step 330 and the process ends.

If the identification of the consumer is verified at step 320, the consumer is given the option of designating the payment as a disputed sum and directing the bank to hold the payment in escrow at step 340. This could occur, in the context of residential housing for example, in a case where a tenant wishes to withhold a lease payment from a landlord because the landlord has failed to provide heat to the apartment. Without the present invention, consumer's rights are effectively prejudiced in a residential lease transaction because a consumer in this situation faces the unenviable choice of making the lease payment to the landlord (thereby losing “leverage” with the landlord to make the repair) or withholding the payment at the risk of receiving a “black mark” in their credit file and potential long term damage to their credit history. By allowing the funds to be directed toward the escrow account, the consumer gets the benefit of showing a timely payment while maintaining the leverage that may be needed to obtain compliance with the lease terms by the lessor. In preferred embodiments of the invention, the conditions under which payments may be designated for escrow and the conditions under which the payments will be released to the creditor or the consumer will be set forth in a written tri-party escrow agreement between the lessor, lessee, and the trust department of the lessor's financial institution.

Payments that are not designated for escrow at step 350 are immediately credited to the creditor's designated account at step 360. Payments that are designated for escrow by the consumer will be stored in the escrow account at step 370 and a notification will be sent to the repository and to the creditor at step 372.

The funds will be held by the bank until the escrow agent is directed to release consumer the funds in accordance with a ruling by a landlord/tenant court, or by a mutually accepted arbitrator, or on some other event agreed upon by the parties. One example of such an event is an adjudication of the dispute by a court of competent jurisdiction. In some preferred embodiments, the consumer is provided with a special code by the bank upon directing a payment to escrow, when the dispute has been resolved (e.g., heat is restored) and the consumer wishes to release the funds to the creditor, the consumer may call a voice automated telephone system maintained by the bank and enter the special code, or may authorize the release online, at which point the bank will release the finds to the creditor. The release event may also comprise an arbitration of the dispute by an entity associated with the repository or some other organization. If the release event (adjudication, arbitration, release by consumer, or other agreed-upon event) indicates that the funds should be released to the creditor at step 374, the payment is credited to the creditor's account at step 360; otherwise, the consumer's account is credited at step 376.

In either event, the bank will also generate a payment report and send the report to the creditor and to the repository management computer 120 at step 380. The payment reporting to the creditor and to the repository includes adjudication or arbitration results in the event payments are escrowed, and the repository tracks the number of times payments are escrowed by the consumer, and what the resolution results are. To the extent that consumers abuse the escrow feature, this information will also be available to future potential creditors.

The bank may charge a fee for its collection and accounting services in some embodiments. This fee provides incentive for the banks to participate in the payment and reporting process. However, this fee will almost certainly be less than the cost that would be incurred by the creditor to handle the payment on its way to the bank. In a sense, the payment collection and accounting services have been outsourced to the bank. In other embodiments, reduced fees will be charged by the banks. In such embodiments, the incentive for the banks comes from the opportunity to attract potential customers that results from consumers being present at the bank when making housing payments. Additional incentive for the bank or other financial institution arises in connection with the Community Reinvestment Act (CRA). In a written opinion expressed by the Federal Reserve Board of Governors, Division of Consumer and Community Affairs, banks can receive favorable “community development service” consideration when they use their lock box payment processing and information reporting technology to assist low and moderate income apartment renters to build accurate credit histories.

In some embodiments, a consumer can make a payment using an automated clearing house (ACH) transaction or an ATM (automated teller machine) in the same manner in which such networks are used to make deposits and pay bills. The appropriate account (creditor or escrow) is then credited and notification of the payment is sent to the repository management computer 120 for storage in the database 122. In preferred embodiments, the ATM, or the financial institution's bank by phone or internet system can alternatively be used to electronically transfer funds from the consumer's account to the creditor's account at greatly reduced processing cost.

The repository management computer 120 uses the bank report to maintain the payment history information for the consumer in the database 122. The consumer can obtain this information from the repository using a secure Internet connection at no charge. This allows the consumer to verify that the information is correct. This payment information will be added to existing payment information for use when the consumer next makes an application for credit.

Obviously, numerous other modifications and variations of the present invention are possible in light of the above teachings. It should be understood that tie invention may be applied to a wide range of credit situations, including residential housing credit, utility credit, retail credit including automobile and furniture loans and credit cards, etc. It is therefore to be understood that within the scope of the appended claims, the invention may be practiced otherwise than as specifically described herein.

What is claimed is:

1. A computerized method for collecting and report payment information comprising:
storing on an electronic storage medium actual payment data from payment processors, the actual payment data pertaining to actual payments made on behalf of a plurality of consumers or business owners, the actual payment data including a biller account name and account number, a payor's name, an amount paid and a date on which the amount was paid for each payment;
reporting, to a party other than a party to whom the payment was due, an indication of the regularity of the timing and amount of the actual payments.

2. The method of claim 1, wherein the payment information is residential housing payments.

3. The method of claim 1, wherein the payment information is utility payments.

4. The method of claim 1, wherein the payment information is retail credit payments.

5. The method of claim 4, wherein the payment information is automobile payments.

6. The method of claim 4, wherein the payment information is consumer finance payments.

7. The method of claim 1, wherein the indication comprises a credit score.

8. The method of claim 1, wherein the reporting step is only performed if the consumer or business owner to whom the indication pertains authorizes the release of the indication.

9. The method of claim 1, wherein the payments made by the consumer or business owner may be designated by the consumer or business owner as disputed and held in a lock box.

10. The method of claim 1, further comprising the step of:
directing, by the consumer or business owner, the payment processor to report the payment data to the entity responsible for performing the storing step.

11. A system for collecting and reporting payment information comprising:
an electronic storage medium, and
a processor connected to the electronic storage medium;
wherein the processor is configured to perform the steps of
collecting actual payment data from a plurality of payment processors, the actual payment data pertaining to actual payments made on behalf of a plurality of consumers or business owners, the actual payment data for each of the actual payments including a biller account identifier that identifies the biller and the account number, a payor identifier that identifies the consumer or business owner on whose behalf the payment was made, an amount of the payment and a date on which the amount was paid;
storing the actual payment data on the electronic storage medium; and
reporting, to a party other than a party to whom the payments were due, an indication of a regularity of the timing and amount of the actual payments made by at least one consumer or business owner.

12. The system of claim 11, wherein the indication relates to residential housing payments.

13. The system of claim 11, wherein the indication relates to retail credit payments.

14. The system of claim 11, wherein the indication relates to utility payments.

15. The system of claim 11, wherein the indication relates to automobile payments.

16. The system of claim 11, wherein the indication relates to consumer finance payments.

17. The system of claim 11, wherein the indication comprises a credit score.

18. The system of claim 11, wherein the reporting step is only performed if the consumer or business owner to whom the indication pertains authorizes the release of the indication.

19. The system of claim 11, wherein the payments made by the consumer or business owner may be designated by the consumer or business owner as disputed and held in a lock box.

20. The system of claim 11, wherein the indication comprises a variance.
